(19) United States
(12) Patent Application Publication
(10) Pub. No.: US 2021/0022352 A1
(43) Pub. Date: Jan. 28, 2021

(54) DOUGH COMPOSITION AND PROCESS FOR MANUFACTURE

(71) Applicant: Prester Foods Inc., Regina (CA)

(72) Inventor: Angela Oladiwura, Regina, SK (CA)

(73) Assignee: Prester Foods Inc., Regina, SK (CA)

(21) Appl. No.: 16/968,076

(22) PCT Filed: Jan. 7, 2019
(86) PCT No.: PCT/CA2019/050019

§ 371 Date: Aug. 6, 2020

Related U.S. Application Data
(60) Provisional application No. 62/627,079, filed on Feb. 6, 2018.

(51) Int. Cl. A21D 13/045; A21D 2/18; A21D 2/26; A21D 2/36; A21D 13/062; A21D 13/066

(52) U.S. Cl. CPC A21D 13/045; A21D 2/183; A21D 2/186; A21D 13/066; A21D 2/36; A21D 13/062; A21D 2/266

(57) ABSTRACT

A dough composition and manufacturing process suitable for a ketogenic diet, a low carbohydrate diet, a sugar-restricted diet, and/or a gluten-restricted diet. The dough composition comprises psyllium powder of 4% wt.; gum of 2% wt. to 4% wt.; pea protein of between 16-20% wt.; pea fibre of between 18-49% wt.; and chickpea flour of between 0-27% wt. Another dough composition comprises cauliflower powder of between 0-8% wt.; psyllium powder of between 5-10% wt.; flax meal of between 0-10% wt.; pea protein of between 15-36% wt.; pea fibre of between 18-46.5% wt.; and oat flour of between 0-25% wt. Finally, another dough composition comprises psyllium powder of 10% wt.; cauliflower powder of between 0-12.5% wt.; pea protein of between 18-31.5% wt.; pea fibre of between 22-42% wt.; baking powder of between 1-3.25% wt.; and salt of between 0.75-1.7% wt.

### RELATED APPLICATIONS

The present application is a National Phase entry of PCT Application No. PCT/CA2019/050019, filed Jan. 7, 2019, which claims the benefit of U.S. Provisional Patent Application No. 62/627,079, filed Feb. 6, 2018, said applications being hereby incorporated by reference herein in their entireties.

### FIELD

This invention relates to a dough composition and the manufacturing process. In particular, the invention relates to a dough composition suitable for a ketogenic diet, a low carbohydrate diet, a sugar-restricted diet, a gluten-restricted diet, and/or any combination thereof.

### BACKGROUND

Dietary staples, such as rice and wheat-based accompaniments form a large portion of the daily diets around the world.

### SUMMARY

The aspects as provided herein, in any and all combinations, relate to a dough composition suitable for a ketogenic diet, a low carbohydrate diet, a sugar-restricted diet, a gluten-restricted diet, and/or any combination thereof.

In a particular aspect, there is provided a flour or dough mix comprising: a psyllium powder of approximately 4 percent weight (% wt.); a gum of approximately 2% wt. to 4% wt.; a pea protein in a range of 16% wt. to 20% wt.; a pea fiber in a range of 18% wt. to 49% wt.; and a chickpea flour in a range of 0% wt. to 27% wt. The pea fiber may be selected from 18% wt., 20% wt., 25% wt., 26% wt., 32% wt., 37% wt., 38% wt., 39% wt., 44% wt., 47% wt. and 49% wt. The chickpea flour may be selected from 0% wt., 4.5% wt., 8% wt., 10% wt., 13% wt., 14.5% wt., 15% wt., 15.5% wt., 16% wt., and 27% wt. The gum may be an acacia gum, a xanthan gum, a guar gum, or any combination thereof combination of the xanthan gum and the guar gum. The flour or dough mix may comprise a protein content between 18.7% wt. to 24.92% wt. The flour or dough mix may comprise a fiber content of between 25.36% wt. to 55.92% wt.

In another aspect, the flour or dough mix may further comprise: a lentil flour in a range of 0% wt. to 27% wt. The lentil flour may be selected from 0% wt., 5% wt., 10% wt., 11.5% wt., 14% wt., and 27% wt. In yet another aspect, the flour or dough mix may further comprise: a cauliflower powder of approximately 2.5% wt. In yet another aspect, the flour or dough mix may further comprise: a coconut flour of approximately 8% wt. In yet another aspect, the flour or dough mix may further comprise: a cabbage powder of approximately 2.5% wt. In yet another aspect, the flour or dough mix may further comprise: an oat flour in a range of approximately 4.5% wt. to 16% wt. In yet another aspect, the flour or dough mix may further comprise: a tapioca flour of approximately 5% wt. or approximately 8% wt. In yet another aspect, the flour or dough mix may further comprise: an inulin powder of approximately 8% wt. In yet another aspect, the flour or dough mix may further comprise: a sugar alcohol of approximately 2% wt. to 8%. In yet another aspect, the flour or dough mix may further comprise: a potato starch of approximately 8% wt. In yet another aspect, the flour or dough mix may further comprise: a baking soda of approximately 2% wt. In yet another aspect, the flour or dough mix may further comprise: salt and flavoring of approximately 4% wt. In yet another aspect, the flour or dough mix may further comprise: a cinnamon powder of approximately 2% wt. In yet another aspect, the flour or dough mix may further comprise: a green banana powder of approximately 0% wt. to 16% wt.

In another particular aspect, there is provided a flour or dough mix comprising: a cauliflower powder in a range of 0% wt. to 8% wt.; a psyllium powder of approximately 5% wt. to 10% wt.; a flax meal of in a range of 0% wt. to 10% wt.; a pea protein in a range of 15% wt. to 36% wt.; a pea fiber in a range of 18% wt. to 46.5% wt.; and an oat flour in a range of 0% wt. to 25% wt. The pea protein may be selected from 15% wt., 16% wt., 20% wt., 21% wt., 23.5% wt., 25% wt., and 36% wt. The pea fiber may be selected from 18% wt., 29% wt., 32% wt., 34% wt., 44% wt., and 46.5% wt. The flax meal may be selected from 5% wt., 9% wt., and 10% wt. The oat flour may be selected from 5% wt., 9% wt., 10% wt., 20% wt., and 25% wt.

In another aspect, the flour or dough mix may further comprise: a oat fiber in a range of 14% wt. to 15% wt. In yet another aspect, the flour or dough mix may further comprise: an unripe plantain flour of approximately 25% wt. In another aspect, the flour or dough mix may further comprise: a coconut flour of approximately 7% wt. In another aspect, the flour or dough mix may further comprise: a baking powder of approximately 2.25% wt.

In another particular aspect, there is provided a flour or dough mix comprising: a psyllium powder of approximately 10% wt.; a cauliflower powder in a range of 0% wt. to 12.5% wt.; a pea protein in a range of 18% wt. to 31.5% wt.; a pea fiber in a range of 22% wt. to 42% wt.; a baking powder in a range of 1% wt. to 3.25% wt.; and a salt in a range of 0.75% wt. to 1.7% wt. The pea protein may be selected from 18% wt., 21.5% wt., 24% wt., 26% wt., 28% wt., 30% wt., and 31.5% wt. The pea fiber may be selected from 22% wt., 27% wt., 31% wt., 32% wt., 34.7% wt., 37% wt., and 42% wt.

In another aspect, the flour or dough mix may further comprise: a cauliflower powder of selected from 0% wt., 4% wt., 5% wt., and 12.5% wt. In another aspect, the flour or dough mix may further comprise: an oat flour in a range of 7% wt. to 15% wt. The oat flour may be selected from 7% wt., 10% wt., 10.5% wt., 11% wt., and 15% wt. In yet another aspect, the flour or dough mix may further comprise: a coconut flour in a range of 7% wt. to 9% wt. In yet another aspect, the flour or dough mix may further comprise: a flax meal in a range of 9% wt. to 10% wt. In even yet another aspect, the flour or dough mix may further comprise: a baking soda in a range of 1% wt. to 1.7% wt. In another aspect, the flour or dough mix may further comprise: a tapioca flour of approximately 5% wt. In another aspect, the flour or dough mix may further comprise: a sweetener of approximately 0.5% wt. In another aspect, the flour or dough mix may further comprise: oat fiber of approximately 15% wt.

### DETAILED DESCRIPTION

According to one aspect described herein, there is provided a dough composition having low carbohydrates that may be suitable for type-2 diabetics. As disclosed in Tattersall R. In: Anonymous Diabetes: the biography. Oxford: Oxford University Press; 2009: 229, herein explicitly incorporated by reference in its entirety, diabetes was considered to be a disease of carbohydrate metabolism. Prior to the discovery of insulin in 1921, diabetic patients were placed on low carbohydrate diets as treatment. The low carbohydrate diets in type 2 diabetics has been shown to be useful in achieving short-term reduction in weight, glycaemia, and/or cardiovascular risk factors from Dyson P. Low Carbohydrate Diets and Type 2 Diabetes: What is the Latest Evidence? Diabetes therapy: research, treatment and education of diabetes and related disorders 2015; 6 (4):411-424, herein explicitly incorporated by reference in its entirety. Nevertheless, long term use of low carbohydrate diets may be unsustainable because of lack of diet variety leading to poor compliance. Evidence supporting the efficacy of these diets remains weak when it relates to long term use of reduced carbohydrate diets for improved management of conditions such type 2 diabetes.

According to another aspect described herein, there is provided a dough composition having low carbohydrates that may be suitable for overweight patients. One study has shown that low carbohydrate intake in overweight patients with diabetes results in larger reductions in dosages of diabetes-related medication. (Saslow L R, Daubenmier J J, Moskowitz J T, et al. Twelve-month outcomes of a randomized trial of a moderate-carbohydrate versus very low-carbohydrate diet in overweight adults with type 2 diabetes mellitus or prediabetes. Nutrition & Diabetes 2017; 7 (12):304-017-0006-9, herein explicitly incorporated by reference in its entirety).

According to yet another aspect described herein, there is provided a dough composition for a ketogenic diet. A ketogenic diet may result in weight loss, may maintain a healthy weight and/or may assist in treatment of specific conditions such as epilepsy. For example, Augustin et al. discloses that ketogenic diets generate ketones which provide brain cells with an energy source more efficient than glucose resulting in better seizure control for refractory epilepsy (Augustin K, Khabbush A, Williams S, et al. Mechanisms of action for the medium-chain triglyceride ketogenic diet in neurological and metabolic disorders. The Lancet Neurology 2018; 17 (1):84-93, herein explicitly incorporated by reference in its entirety).

According to another aspect herein, there is provided a dough composition for individuals with gluten intolerance and/or other common allergies such as nuts.

The dough compositions described herein may fall into one or more of the following: low carbohydrate, low sugar, high protein, high fiber (LC-LS-HP-HF), and/or any combination thereof. The dough compositions may be formed into a vegetable pellet that may act as a rice replacement, a pasta alternative, a cereal, a crispy snack, or as an alternative (LC-LS-HP-HF) vegetable flour for baked goods and African swallow staple foods.

A range of mainly vegetable-based dough compositions as described in further detail below may comprise food materials having low glycaemic index. Within the range, slight variations in individual constituents and methods of processing with or without the use of twin screw die extrusion may help create a plurality of end-use products. These variations within individual constituents may introduce differing texture, taste, and/or appearance producing end-use products that may be eaten alongside a range of common accompaniments for use in meals at different times of the day.

According to the aspects herein, there is provided a number of variable formulations of low carbohydrate, low sugar, high protein, and/or high fiber compositions derived from vegetables suitable to be used as an alternative or replacement for common staple foods, such as rice or pasta, cereal, crispy snack, a versatile flour for baking and making the “West African style swallow” (e.g. a dough-like accompaniment for delicacy soups). The African swallow is a staple food conventionally made from flours such as rice, yam, cassava, wheat, corn, sorghum to form a thick porridge similar to western mash potato. A swallow is typically thick, elastic, and/or easily malleable with a dough-like consistency once prepared. The conventional swallow comprises mostly starchy solids. As described in further detail below, the compositions may be processed using an extrusion process, such as disclosed in U.S. Pat. No. 5,989,620 to Wang et al., filed Sep. 19, 1997, herein explicitly incorporated by reference in its entirety, to produce an imitation rice pellet. According to some aspects, the rice pellet may be produced using a twin screw extruder.

A formulation may be fed into an extruder under defined moisture conditions and operational settings such that a plurality of pellets may be created having variable forms of a low carbohydrate, low sugar, high protein, and/or high fiber. The combination of the ingredients and the extrusion methodology enhanced the end product by providing a low carbohydrate product with a low sugar content having less than or equal to 5-g/100-g.

In order to create a low carbohydrate imitation rice pellet from plant based ingredients and, in particular, a low sugar product, a thorough formulation and composition analysis was performed such that the end product is pleasant and neutral taste with a good texture in keeping with an appearance and taste of naturally grown rice. For instance, the use of coconut powder allowed the product to have aesthetic white particulate similar to rice with an enhanced taste. For example, if an imitation rice is created using a single low carbohydrate vegetable powder ingredient such as cauliflower 43% wt., with psyllium powder 4% wt., binding agent acacia 2% wt., pea protein 21% wt. and pea fiber 30% wt., even though a low carbohydrate product is achieved, the sugar content far exceeds what is considered acceptable. In this case, 17-g/100-g of carbohydrate without sugar, 11-g/100-g of sugar, protein is 29.7-g/100-g and the fiber content is approximately 42.5-g/100-g. The total digestible carbohydrate is roughly 28-g/100-g of end product. The range of ingredient presented in the following tables with composition takes into consideration the varying amounts that ensure low carbohydrate, low sugar, high protein and high fiber. There are three types of carbohydrate, namely starch, sugar, and fiber. Herein, the carbohydrate content is presented as digestible component (e.g. starch & sugar) and represent the indigestible component as fiber. The consumption of indigestible carbohydrate does not influence blood sugar.

In this aspect, a twin-screw extruder with defined feed rate and established operating conditions may be used. For example, a dry ingredient feed rate may be 20-kg/hour. A water feed rate may be 14.6-kg/hour resulting in a moisture content of approximately 46%. An extruder barrel temperature may be about 40-degrees Celsius, and a die temperature may be about 56-degrees Celsius. Modifications may be made to these operating conditions to achieve certain product characteristics. Oil may be introduced to the liquid feed rate up to a maximum of 10% of the liquid feed rate to change the characteristics of a resultant pellet. For example, a water rate of 13.14-kg/hour and an oil rate of 1.46-kg/hour may be used. The created pellets are dried after extrusion. Examples of the dough compositions are provided below.

According to Examples 1A to 1U below, a combination of vegetable powder may be fed through the extruder with water added to allow a creation of pellets that resemble conventionally grown rice or in other aspects, a pasta product. The form or extrusion shape may vary and may not be limited to rice shape. The combination of ingredients may be varied such that a low carbohydrate, low sugar, high fiber and high protein staple end product may be created. For a rice/pasta/cereal/crispy snack end-use, the range of ingredients may generally comprise the general ranges of Table 1 below.

TABLE 1

| Ingredient | % wt. |
|---|---|
| Cauliflower Powder | 0-45 |
| Cabbage Powder | 0-45 |
| Psyllium Power | 0-35 |
| Coconut Flour | 0-28 |
| Acacia Gum/Xanthan/Guar/other | 0-5 |
| Lentil Flour | 0-55 |
| Pea Protein/Faba Protein/Chickpea Protein/other | 0-70 |
| Pea Fiber/Faba Fiber/Chickpea Fiber/other | 0-70 |
| Chickpea Flour | 0-55 |
| Oat Flour | 0-30 |
| Oat Fiber | 0-70 |
| Tapioca flour | 0-15 |
| Potato Starch/other | 0-14 |
| Dry beans flour | 0-55 |
| Faba beans/Broad beans flour | 0-55 |
| Dry Pea flour | 0-55 |
| Cowpeas flour | 0-55 |
| Bambara Flour | 0-60 |
| Pigeon pea flour | 0-55 |
| Vetches flour | 0-55 |
| Lupin flour | 0-55 |
| Lupin protein | 0-70 |
| Soy beans flour | 0-55 |
| Hemp protein | 0-70 |
| Soy protein | 0-70 |
| Amaranth flour | 0-50 |
| Quinoa flour | 0-50 |
| Quinoa grains | 0-70 |
| Teff flour | 0-55 |
| Lima bean powder | 0-50 |
| Buckwheat powder | 0-20 |
| Wild rice flour | 0-50 |
| Chia Seed powder | 0-40 |
| Cranberry Protein | 0-70 |
| Sacha Inchi protein powder | 0-70 |
| Sorghum flour | 0-55 |
| Unripe plantain/Green banana powder | 0-30 |
| Arrowroot Powder | 0-10 |
| Inulin Fiber | 0-40 |
| Potato Fiber | 0-70 |
| Apple fiber | 0-70 |
| Banana fiber | 0-70 |
| Sugar Beet fiber | 0-70 |
| Sugar cane fiber | 0-70 |
| Soy hull fiber | 0-70 |
| Bamboo fiber | 0-70 |
| Corn hull fiber/Corn Bran | 0-70 |
| Cottonseed fiber | 0-70 |

The total vegetable component, not including pea fiber, pea protein, binding agent—such as psyllium husk, acacia, starch, may not exceed approximately 32% to approximately 35%. Cauliflower, Cabbage, and Coconut flour are plant based ingredients that are low in carbohydrate but relatively high in sugar compared to pulses such as Lentil, Chickpea, and the low glycemic index grain e.g. Oat. The legume and pulse ingredients have significantly less sugar content. The pellet rice grain stability and texture may be improved by including minimal amount of starch, such as tapioca flour, even though this ingredient is high in carbohydrate. The choice of ingredients, formulation and interaction of these ingredients enable the creation of end products having desirable features. There is no natural food equivalent currently in existence with the nutritional composition of the intended product. In particular, pea fiber provides a benefit to the end product. In addition oat fiber may provide an improved texture with zero nutritive calorie content. Pea fiber may be substituted by faba fiber, chickpea fiber, or other plant fiber. Pea protein may be substituted by faba protein, chickpea protein, or other plant-based protein. A detailed list of a range of ingredients is presented herein for each dough composition.

In a particular Example 1A formulation, the ingredients may comprise cauliflower powder, cabbage powder, psyllium powder, coconut flour, acacia gum, lentil flour, pea protein, pea fiber, chickpea flour, and oat flour. Each ingredient may have a percent weight in accordance with Table 2A.

A 100-g of the resultant rice/pasta-like end use product may have a nutritive content of approximately 9-g of other carbohydrate, approximately 4-g of sugar, approximately 23-g of protein, and less than or equal to approximately 56-g of fiber. The total digestible carbohydrate is 13-g/100-g of end product. The expected variation may be +/−20-g as per class II nutrients tolerance. In comparison, a 100-g of conventional rice contains 78.5-g of total carbohydrates of which 0.2-g is sugar, 1.3-g is fiber, and protein content of 7-g. (source: http://www.foodnutritiontable.com/voedingswaarde/voedingsmiddel/?id=795 retrieved on Jun. 27, 2018).

In another particular Example 1B formulation, the ingredients may comprise cauliflower powder, psyllium powder, acacia gum, lentil flour, pea protein, pea fiber, and chickpea flour. In this example, the cabbage powder, coconut flour, and oat flour have been removed from Example 1A. The lentil flour has been approximately doubled over Example 1A and the chickpea flower has been increased to 14.5%. Each ingredient may have a percent weight in accordance with Table 2A.

A 100-g of the resultant rice/pasta-like end use product may have the nutritive content of approximately 13-g of other carbohydrate, approximately 2-g of sugar, approximately 24.5-g of protein, and approximately 53-g of fiber. The total digestible carbohydrate is 15-g/100-g of end product.

In yet another particular Example 1C formulation, the ingredients may comprise psyllium powder, acacia gum, lentil flour, pea protein, pea fiber, and chickpea flour. In this example, the cauliflower powder has been removed from the Example 1B and a corresponding increase has been made to the lentil flour (1.5%) and chickpea flour (1%). The cauliflower powder has been removed in order to reduce the total sugar content while creating a desirable variance in taste and texture. Each ingredient may have a percent weight in accordance with Table 2A.

A 100-g of the resultant rice/pasta-like end use product may have the nutritive content of approximately 14-g of other carbohydrate, approximately 1.5-g of sugar, approximately 25-g of protein, and approximately 53-g of fiber. The total digestible carbohydrate is approximately 15.5-g/100-g of end product.

In another particular Example 1D formulation, the ingredients may comprise cauliflower powder, cabbage powder, psyllium powder, coconut flour, acacia gum/xanthan/guar/other, lentil flour, pea protein, pea fiber, chickpea flour, oat flour, and tapioca flour. The particular combination of ingredients may create a desirable change in texture. Each ingredient may have a percent weight in accordance with Table 2A presenting Examples 1A to 1F.

A 100-g of the resultant rice/pasta-like end use product may have the nutritive content of approximately 13-g of other carbohydrate, approximately 4-g of sugar, approximately 23-g of protein, and approximately 51-g of fiber. The total digestible carbohydrate is 17-g/100-g of end product.

In a particular Example 1E formulation, the ingredients may comprise psyllium powder, acacia gum, pea protein, pea fiber, chickpea flour, and tapioca flour or tapioca starch. This formulation is similar to Example 1C, except for the removal of lentil flour, an increase in chickpea, reduction of pea fiber and inclusion of tapioca flour to create a change in taste.

A 100-g of the resultant rice/pasta-like end use product may have a nutritive content of approximately 17-g of other carbohydrate, approximately 2-g of sugar, approximately 24-g of protein, and less than or equal to approximately 49-g of fiber. The total digestible carbohydrate is 19-g/100-g of end product.

In Example 1F formulation, is similar to Example 1A except for an increase in acacia gum and a corresponding decrease in pea fiber, this change reduced the mineral losses observed during cooking of end product.

A 100-g of the resultant rice/pasta-like end use product may have a nutritive content of approximately 9-g of other carbohydrate, approximately 4-g of sugar, approximately 23-g of protein, and less than or equal to approximately 56-g of fiber. The total digestible carbohydrate is 13-g/100-g of end product.

In Example 1G formulation, is similar to Example 1E formulation, the ingredients may comprise psyllium powder, acacia gum, pea protein, pea fiber, lentil flour, and tapioca flour. The chickpea fraction of formulation 1E has been replaced by lentil flour to change the taste of the resultant and to further reduce the sugar component of the end product.

A 100-g of the resultant rice/pasta-like end use product may have a nutritive content of approximately 19-g of other carbohydrate, approximately 1-g of sugar, approximately 25-g of protein, and less than or equal to approximately 47-g of fiber. The total digestible carbohydrate is 21-g/100-g of end product.

TABLE 1
Example 1A to 1G Formulations

| | Example - | Example - | Example - | Example - | Example - | Example - | Example - |
|---|---|---|---|---|---|---|---|
| | 1A | 1B | 1C | 1D | 1E | 1F | 1G |
| Ingredient | (% wt.) | (% wt.) | (% wt.) | (% wt.) | (% wt.) | (% wt.) | (% wt.) |
| Cauliflower | 2.5 | 2.5 | 0 | 2.5 | 0 | 2.5 | 0 |
| powder | | | | | | | |
| Cabbage powder | 2.5 | 0 | 0 | 2.5 | 0 | 2.5 | 0 |
| Psyllium powder | 4 | 4 | 4 | 4 | 4 | 4 | 4 |
| Coconut flour | 8 | 0 | 0 | 8 | 0 | 8 | 0 |
| Acacia gum | 2 | 2 | 2 | 2 | 2 | 4 | 2 |
| Lentil flour | 5 | 10 | 11.5 | 5 | 0 | 5 | 27 |
| Pea protein | 18 | 18 | 18 | 18 | 18 | 18 | 18 |
| Pea fiber | 49 | 49 | 49 | 44 | 44 | 47 | 44 |
| Chickpea flour | 4.5 | 14.5 | 15.5 | 4.5 | 27 | 4.5 | 0 |
| Oat flour | 4.5 | 0 | 0 | 4.5 | 0 | 4.5 | 0 |
| Tapioca flour | 0 | 0 | 0 | 5 | 5 | 0 | 5 |
| Total Composition | 100 | 100 | 100 | 100 | 100 | 100 | 100 |
| % Carbs of which | 4.05 | 1.98 | 1.46 | 4.05 | 1.62 | 4.05 | 1.24 |
| Sugar | | | | | | | |
| % Carbs (excludes | 8.96 | 13.08 | 13.94 | 13.13 | 17.15 | 8.88 | 19.41 |
| fiber + Sugar) | | | | | | | |
| Protein % | 23.21 | 24.51 | 24.56 | 22.98 | 23.90 | 23.14 | 24.92 |
| Fiber % | 55.92 | 53.12 | 52.83 | 51.42 | 49.05 | 55.82 | 47.36 |

According to Examples 1H and 1N presented in Table 2B below, the formulation may be suitable for cereal and a savory crispy/crunchy snack which may use the extrusion processing method. In the particular for Example 1H, the ingredients may comprise; psyllium powder, coconut flour, pea protein/faba protein/chickpea protein, pea fiber/oat fiber/apple fiber/chickpea fiber, chickpea powder, inulin powder (for creamy taste), cinnamon flavor (for weight loss characteristic and taste), sugar alcohol/sweetener, and salt. The other carbohydrate content for 100-g of the cereal is 15-g, 3-g of sugar, approximately 22-g of protein, and roughly 47-g of fiber. The total digestible carbohydrate is 18-g/100-g of end product. The cereal may be fortified with minerals and vitamins.

In another Example 11, the ingredients may comprise: psyllium powder, pea protein/faba protein/chickpea protein/other, pea fiber/oat fiber/apple fiber/chickpea fiber/other, chickpea flour, potato starch, lentil flour, salt, and flavoring. The examples of flavoring may include vinegar, curry, cheese, onion, and barbeque, etc. The 100-g of savory crispy snack contains approximately 21-g of other carbohydrate, sugar of 2.62-g, roughly 21-g of protein and 40-g of fiber. The total digestible carbohydrate is roughly 23-g/100-g of the end product.

TABLE 2B
Example 1H to 1N Formulation for Cereal or Crispy Snack

| | Example | Example | Example | Example | Example | Example | Example |
|---|---|---|---|---|---|---|---|
| | 1H | 1I | 1J | 1K | 1L | 1M | 1N |
| Ingredient | (% wt.) | (% wt.) | (% wt.) | (% wt.) | (% wt.) | (% wt.) | (% wt.) |
| Psyllium powder | 4.00 | 4.00 | 4.00 | 4.00 | 4.00 | 4.00 | 4.00 |
| Coconut Flour | 8.00 | 0 | 8.00 | 8.00 | 8.00 | 8.00 | 8.00 |
| Xanthan gum | 2.00 | 2.00 | 2.00 | 3.00 | 2.00 | 2.00 | 2.00 |
| Pea protein/Faba | 18.00 | 16.00 | 18.00 | 18.00 | 18.00 | 18.00 | 18.00 |
| protein/Chickpea | | | | | | | |
| protein/Other | | | | | | | |
| Pea Fiber/Oat | 39.00 | 37.00 | 38.00 | 37.00 | 37.00 | 32.00 | 25.00 |
| fiber/Apple fiber/ | | | | | | | |
| Chickpea fiber/Corn | | | | | | | |
| hull fiber/corn diet | | | | | | | |
| fiber/Other | | | | | | | |
| Chickpea flour | 15.00 | 13.00 | 15.00 | 15.00 | 15.00 | 10.00 | 10.00 |
| Potato starch | 0 | 8.00 | 0 | 0 | 0 | 0 | 0 |
| Lentil flour | 0 | 14.00 | 0 | 0 | 0 | 0 | 0 |
| Inulin Powder | 8.00 | 0 | 8.00 | 8.00 | 8.00 | 8.00 | 8.00 |
| Oat flour | 0 | 0 | 0 | 0 | 0 | 10 | 10 |
| Guar Gum | 0.00 | 0.00 | 0 | 0 | 1.00 | 1.00 | 1.00 |
| Cinnamon powder | 2.00 | 0 | 2.00 | 2.00 | 1.00 | 2.00 | 1.00 |
| Salt | 2.00 | 2.00 | 1.00 | 1.00 | 1.00 | 1.00 | 2.00 |
| Flavorings (e.g. | 0 | 2.00 | 0 | 0 | 1.00 | 0 | 1.00 |
| vanilla, lemon, etc.) | | | | | | | |
| Baking soda | 0 | 2.00 | 0 | 0 | 0 | 0 | 0 |
| Sugar Alcohol/ | 2.00 | 0 | 3.00 | 3.00 | 3.00 | 3.00 | 4.00 |
| Sweetener | | | | | | | |
| Vitamins & | 0 | 0 | 1.00 | 1.00 | 1.00 | 1.00 | 1.00 |
| minerals | | | | | | | |
| Tapioca starch/ | 0 | 0 | 0 | 0 | 0 | 0 | 5.00 |
| corn starch/other | | | | | | | |
| Total composition | 100 | 100 | 100 | 100 | 100 | 100 | 100 |
| % Carbs of which | 2.8 | 2.24 | 2.62 | 2.66 | 2.75 | 2.55 | 2.66 |
| sugar | | | | | | | |
| % Carbs excluding | 14.83 | 20.93 | 21.17 | 20.94 | 19.90 | 23.81 | 30.14 |
| fiber + Sugar | | | | | | | |
| % Protein | 22.2 | 18.7 | 21.22 | 21.25 | 21.17 | 21.31 | 20.95 |
| % fiber | 47.0 | 40.34 | 39.73 | 39.81 | 39.37 | 36.28 | 30.89 |

According to Examples 1O and 1U presented in Table 2C below, further formulation may be suitable for cereal and a savory crispy/crunchy snack which may use the extrusion processing method.

TABLE 2C
Example 1O to 1U Formulation for Cereal or Crispy Snack

| | Example | Example | Example | Example | Example | Example | Example |
|---|---|---|---|---|---|---|---|
| | 1O | 1P | 1Q | 1R | 1S | 1T | 1U |
| Ingredient | (% wt.) | (% wt.) | (% wt.) | (% wt.) | (% wt.) | (% wt.) | (% wt.) |
| Psyllium powder | 4.00 | 4.00 | 4.00 | 4.00 | 4.00 | 4.00 | 4.00 |
| Coconut Flour | 8.00 | 8.00 | 8.00 | 8.00 | 8.00 | 8.00 | 8.00 |
| Xanthan gum | 2.00 | 2.00 | 2.00 | 2.00 | 2.00 | 2.00 | 2.00 |
| Pea protein/Faba | 20.00 | 20.00 | 20.00 | 20.00 | 20.00 | 20.00 | 20.00 |
| protein/Chickpea | | | | | | | |
| protein/Other | | | | | | | |
| Pea fiber/Oat fiber/ | 20.00 | 20.00 | 20.00 | 26.00 | 18.00 | 18.00 | 18.00 |
| Apple fiber/Chickpea | | | | | | | |
| fiber/Corn hull fiber/ | | | | | | | |
| corn diet fiber/Other | | | | | | | |
| Chickpea powder | 8.00 | 0.00 | 0.00 | 8.00 | 16.00 | 0.00 | 8.00 |
| Inulin Powder | 8.00 | 8.00 | 8.00 | 0.00 | 0.00 | 0.00 | 8.00 |
| Green Banana | 0 | 8.00 | 0 | 0 | 0 | 16.00 | 0 |
| flour | | | | | | | |
| Oat flour | 8.00 | 8.00 | 16.00 | 8.00 | 8.00 | 8.00 | 8.00 |
| Guar Gum | 1.00 | 1.00 | 1.00 | 1.00 | 1.00 | 1.00 | 1.00 |
| Cinnamon powder | 1.00 | 1.00 | 1.00 | 2.00 | 2.00 | 2.00 | 2.00 |
| Salt | 2.00 | 2.00 | 2.00 | 2.00 | 2.00 | 2.00 | 2.00 |
| Flavorings (e.g. | 1.00 | 1.00 | 1.00 | 2.00 | 2.00 | 2.00 | 2.00 |
| vanilla, lemon, | | | | | | | |
| etc.) | | | | | | | |
| Sugar Alcohol/ | 8.00 | 8.00 | 8.00 | 8.00 | 8.00 | 8.00 | 8.00 |
| Sweetener | | | | | | | |
| Vitamins & | 1.00 | 1.00 | 1.00 | 1.00 | 1.00 | 1.00 | 1.00 |
| minerals | | | | | | | |
| Tapioca starch/ | 8.00 | 8.00 | 8.00 | 8.00 | 8.00 | 8.00 | 8.00 |
| corn starch/other | | | | | | | |
| Total composition | 100 | 100 | 100 | 100 | 100 | 100 | 100 |
| % Carbs of which | 2.61 | 2.58 | 2.38 | 2.76 | 3.06 | 3.00 | 2.76 |
| sugar | | | | | | | |
| % Carbs excluding | 33.35 | 35.93 | 34.74 | 27.51 | 29.33 | 34.48 | 33.24 |
| fiber + Sugar | | | | | | | |
| % Protein | 21.55 | 19.93 | 20.84 | 21.87 | 23.39 | 20.14 | 21.50 |
| % fiber | 27.05 | 26.32 | 26.30 | 31.11 | 26.83 | 25.36 | 26.20 |

According to Examples 2A, 2B, 2C, 2D, 2E, and 2F below, the particular formulations may be suitable for producing an African Swallow composition by mixing the formulations presented. The resulting mixture may be cooked using conventional methods with boiling hot water in a pot or in a microwave and mixed to create a smooth paste.

For 100-g of African Swallow (Example 2A & 2B) as describe herein, the amount of carbohydrate without sugar in the end product is 5.4-g and sugar is 2.4-g. The total digestible carbohydrate is roughly 8-g/100-g of the end product. The remainder of the end use product is approximately 36-g of protein, and 47-g fiber. The remaining weight may comprise water, fat, micronutrients and/or ash. For a conventional African Swallow of 100-g, such as “Poundo” yam and Plantain fufu, the conventional African Swallow contains 79-g and 43-g of total carbohydrates respectively. In Table 4, a comparison is presented between Example—2A/2B and the conventional “Poundo” yam and Plantain fufu. An ingredient range for a low carbohydrate, low sugar, high protein and high fiber Swallow may comprise Table 3 below.

TABLE 3

| Ingredient | % wt. |
|---|---|
| Cauliflower powder | 0-30 |
| Cabbage powder | 0-30 |
| Eggplant powder | 0-30 |
| Broccoli Powder | 0-30 |
| Zucchini powder | 0-30 |
| Cucumber powder | 0-30 |
| Psyllium powder | 0-30 |
| Coconut Flour | 0-28 |
| Acacia gum | 0-5 |
| Flax meal | 0-40 |
| Pea Protein/Faba Protein/Chickpea Protein/Other | 0-60 |
| Pea Fiber/Faba fiber/Chickpea fiber/Other | 0-60 |
| Oat fiber | 0-60 |
| Oat Flour/Unripe Plantain flour | 0-30 |
| Tapioca flour | 0-10 |
| Arrowroots | 0-10 |
| Sorghum | 0-55 |

In the particular Example 2A, the ingredients comprise cauliflower powder, psyllium powder, pea protein, pea fiber, flax meal, and oat flour. Similarly low carbohydrates plant based ingredients may be used selectively and in particular ratios to minimize the sugar content and include low sugar ingredients that influence the texture of the end product. In this case, flax meal unexpectedly improves the elasticity of the end product.

TABLE 4
Example 2A to 2F Formulations

| | Example - | Example - | Example - | Example - | Example - | Example - |
|---|---|---|---|---|---|---|
| | 2A | 2B | 2C | 2D | 2E | 2F |
| | Formulation | Formulation | Formulation | Formulation | Formulation | Formulation |
| Ingredient | (% wt.) | (% wt.) | (% wt.) | (% wt.) | (% wt.) | (% wt.) |
| Cauliflower | 5 | 5 | 5 | 5 | 5 | 0 |
| powder | | | | | | |
| Psyllium | 5 | 5 | 5 | 5 | 5 | 5 |
| powder | | | | | | |
| Pea Protein | 36 | 36 | 16 | 21 | 21 | 23.5 |
| Pea Fiber | 44 | 29 | 44 | 44 | 44 | 46.5 |
| Flax meal | 5 | 5 | 5 | 0 | 0 | 0 |
| Oat Flour | 5 | 5 | 25 | 25 | 0 | 0 |
| Oat fiber | 0 | 15 | 0 | 0 | 0 | 0 |
| Unripe | 0 | 0 | 0 | 0 | 25 | 25 |
| plantain | | | | | | |
| powder | | | | | | |
| Total | 100 | 100 | 100 | 100 | 100 | 100 |

In the particular Example 2B, the ingredients comprise cauliflower powder, psyllium powder, pea protein, pea fiber, flax meal, oat flour, and oat fiber to change the texture and create a more neutral flavor. The nutritional content of Example 2A and 2B are the same.

A comparison of the nutritional content of the alternative swallow Example 2A/2B to a plantain swallow and a “Poundo” swallow is presented in Table 5.

TABLE 5
Nutritional Content of Swallows

| | Alternative | Plantain | “Poundo” |
|---|---|---|---|
| Component of Interest | Swallow | Swallow | Swallow |
| Carbs % excluding fiber + | 5.35 | 40 | 75.2 |
| sugar | | | |
| Carbs of which Sugar | 2.42 | 0 | 0.8 |
| Protein % | 36 | 6 | 0.004 |
| Fiber % | 47 | 3 | 3 |

In the particular Example 2C, the ingredients comprise cauliflower powder, psyllium powder, pea protein, pea fiber, flax meal, and oat flour. As may be seen in comparison to Example 2A, oat flour has been increased and a corresponding decrease in pea protein carried out; to alter the texture and flavor. 100-g of the Alternative Swallow flour—Example 2C may contain the following: 17-g of other carbohydrates, 2-g of sugar, 22-g of protein, and 48-g of fib fiber. The total digestible carbohydrate is roughly 19-g/100-g of end product.

In the particular Example 2D, the ingredients comprise cauliflower powder, psyllium powder, pea protein, pea fiber, and oat flour. As may be seen in comparison to Example 2C, pea protein has been increased and the removal of flaxmeal; to increase the protein content, reduce the elasticity and change the appearance of resultant swallow. 100-g of the Alternative Swallow flour—Example 2D may contain the following: 17-g of other carbohydrates, 2-g of sugar, 25-g of protein, and 47-g of fiber. The total digestible carbohydrate is roughly 19-g/100-g of end product.

In the particular Example 2E, the ingredients comprise cauliflower powder, psyllium powder, pea protein, pea fiber, and unripe plantain flour. As compared to Example 2D, the oat flour was removed and an alternative low glycaemic index unripe plantain was included to alter the density and texture of the resultant swallow. 100-g of the Alternative Swallow flour—Example 2E may contain the following: 24-g of other carbohydrates, 2-g of sugar, 22-g of protein, and 45-g of fiber. The total digestible carbohydrate is roughly 26-g/100-g of end product.

In the particular Example 2F, the ingredients comprise psyllium powder, pea protein, pea fiber, and unripe plantain flour. As compared to Example 2E, the cauliflower flour was removed and a 2.5% increase in both pea fiber and pea protein resulting in an altered taste and texture of the swallow and significant protein and fiber content. 100-g of the Alternative Swallow flour—Example 2F may contain the following: 24-g of other carbohydrates, 1-g of sugar, 23-g of protein, and 46-g of fiber. The total digestible carbohydrate is roughly 25-g/100-g of end product. The psyllium powder fraction of the formulations above may be replaced by tapioca starch, yam starch, potato starch or other edible starch as the binding agent.

According to Examples 3A and 3B below, the particular formulations may be suitable for producing a low carbohydrate, low sugar, high protein and high fiber bread by mixing the formulations presented. Similarly low carbohydrates plant based ingredients may be used selectively and in particular ratios to minimize the sugar content and include low sugar ingredients that influence the texture of the end product. In this case, flax meal improves the elasticity of the end product. The ingredients may comprise the ranges according to Table 6 below.

TABLE 6

| Ingredient | % wt. |
|---|---|
| Cauliflower powder | 0-30 |
| Cabbage powder | 0-30 |
| Psyllium powder | 0-30 |
| Coconut Flour | 0-28 |
| Acacia gum | 0-5 |
| Pea Protein/Faba Protein/Chickpea Protein/Other | 0-60 |
| Pea Fiber/Faba Fiber/Chickpea Fiber/Other | 0-60 |
| Oat Fiber | 0-60 |
| Oat Flour | 0-30 |
| Xanthan gum | 0-5 |
| Tapioca flour | 0-5 |
| Flax whole Seed &/Flax seed powder | 0-40 |
| Apple Cider Vinegar | 0-10 |
| Olive/Coconut oil | 0-40 |
| Eggs yolk | 0-60 |
| Egg white | 0-60 |
| Egg protein | 0-60 |
| Water | 0-60 |
| Yeast | 0-10 |
| Bi - Carbonate | 0-10 |
| Baking powder | 0-10 |
| Salt | 0-10 |
| Stevia | 0-10 |
| Other seeds such as Fenugreek powder, buckwheat powder | 0-20 |
| Arrowroots flour | 0-20 |
| Pumpkin seeds | 0-20 |
| Pumpkin seed powder | 0-40 |
| Chia seed powder | 0-40 |
| Chia seeds | 0-20 |
| Unripe Banana flour | 0-45 |

In the particular Example 3A, the ingredients may comprise cauliflower powder, psyllium powder, coconut flour, pea protein, pea fiber, flax meal, oat flour, salt, and baking powder according to the % wt. presented in Table 7.

TABLE 7
Example 3A to 3D Formulations

| | Example - | Example - | Example - | Example - |
|---|---|---|---|---|
| | 3A Formu- | 3B Formu- | 3C Formu- | 3D Formu- |
| | lation | lation | lation | lation |
| Ingredient | (% wt.) | (% wt.) | (% wt.) | (% wt.) |
| Cauliflower | 8.00 | 8.00 | 8.00 | 8 |
| powder | | | | |
| Psyllium | 5.00 | 5.00 | 5.00 | 10 |
| powder | | | | |
| Coconut Flour | 7.00 | 7.00 | 7.00 | 7 |
| Pea Protein | 25.00 | 25.00 | 15.00 | 20 |
| Pea Fiber | 32.00 | 18.00 | 32.00 | 34 |
| Oat Fiber | 0.00 | 14.00 | 0.00 | 0 |
| Flax meal | 10.00 | 10.00 | 10.00 | 9 |
| Oat Flour | 10.00 | 10.00 | 20.00 | 9 |
| Salt | 0.75 | 0.75 | 0.75 | 0.75 |
| Baking Powder | 2.25 | 2.25 | 2.25 | 2.25 |
| Total | 100.00 | 100.00 | 100.00 | 100 |
| Composition % | | | | |
| WT | | | | |

In the particular Example 3B, the ingredients may comprise cauliflower powder, psyllium powder, coconut flour, pea protein, pea fiber, oat fiber, flax meal, oat flour, salt, and baking powder according to the % wt. presented in Table 6. As may be seen, 14% of oat fiber has been substituted for a corresponding decrease in pea fiber; to alter the texture and taste of the product.

The amount of carbohydrates in a 100-g of bread flour mix as per the composition in the Table 6 for Example 3A and Example 3B comprises 8-g of carbohydrate without sugar, 4-g of sugar, protein content of about 30-g, and fiber of about 42-g. The total digestible carbohydrate is roughly 12-g/100-g of end product bread mix. In comparison, 100-g of typical bread flour contains 70-g of total carbohydrate, of which 3.3-gram of fiber, no sugar, and protein of 13-g. The resultant 100-g of bread formed from a mixture of 36-g of the low carbohydrate flour obtained from Example 3A or 3B, 45% of water, 19% of egg, and 1% apple cider vinegar results in bread that comprise of 3-grams of other carbohydrates, 1.5-gram of sugar, approximately 11-g of protein, approximately 15-g of fiber.

In the particular Example 3C, the ingredients may comprise cauliflower powder, psyllium powder, coconut flour, pea protein, pea fiber, flax meal, oat flour, salt, and baking powder according to the % wt. presented in Table 6. As may be seen, 10% wt. of pea protein has been substituted for a corresponding increase in oat flour as compared to Example 3A; to alter the texture and taste of the product.

A 100-g of the bread flour—Example 3C may contain the following: 14-g of other carbohydrate, 4-g of sugar, 20.5-g protein, and 43-g fiber. The total digestible carbohydrate is approximately 18-g/100-g of end product.

In the particular Example 3D, the ingredients may comprise cauliflower powder, psyllium powder, coconut flour, pea protein, pea fiber, flax meal, oat flour, salt, and baking powder according to the % wt. presented in Table 6. As may be seen, 1% wt. reduction of flaxmeal and 11% wt. of oat flour has been substituted for a corresponding increase in psyllium powder, pea protein and pea fiber as compared to Example 3C; to alter the texture, taste of the product and overall calorific content.

A 100-g of the bread flour—Example 3D may contain the following: 7.3-g of other carbohydrate, 4.2-g of sugar, 26-g protein, and 47-g fiber. The total digestible carbohydrate is approximately 11.5-g/100-g of end product.

According to Examples 4A, 4B, and 4C below, the particular formulations may be suitable for producing a low carbohydrate, low sugar, high protein and high fiber cookie or biscuit by mixing the formulations presented. The ingredients may comprise the ranges in Table 8 below.

TABLE 8

| | Composition |
|---|---|
| Ingredient | Range % wt. |
| Cauliflower powder | 0-30 |
| Cabbage powder | 0-30 |
| Psyllium powder | 0-30 |
| Coconut Flour | 0-28 |
| Pea Protein/Faba Protein/Chickpea Protein/Other | 0-60 |
| Pea Fiber/Faba Fiber/Chickpea Fiber/Other | 0-60 |
| Oat Fiber | 0-60 |
| Oat Flour | 0-30 |
| Flax Seed&/Flax whole seeds | 0-40 |
| Olive/Coconut oil | 0-40 |
| Eggs | 0-60 |
| Baking powder | 0-10 |
| Salt | 0-10 |
| Chocolate Chip unsweetened | 0-10 |
| Vanilla Essence | 0-10 |
| Cinnamon powder | 0-10 |
| Lemon Extract | 0-10 |
| Stevia | 0-10 |
| Buckwheat flour | 0-40 |
| Chia seed powder | 0-40 |
| Chia seeds | 0-20 |
| Cranberry protein | 0-70 |
| Sugar Alcohol/Sweetener | 0-10 |

In the particular Example 4A, the ingredients may comprise cauliflower powder, psyllium powder, coconut flour, pea protein, pea fiber, oat flour, flax meal, salt, and baking powder according to the % wt. presented in Table 9.

TABLE 9
Example 4A to 4C Formulations

| | Example - 4A | Example - 4B | Example - 4C |
|---|---|---|---|
| | Formulation | Formulation | Formulation |
| Dry Ingredients | (% wt.) | (% wt.) | (% wt.) |
| Cauliflower Powder | 4 | 4 | 4 |
| Psyllium Powder | 10 | 10 | 10 |
| Coconut flour | 7.00 | 7.00 | 7.00 |
| Pea Protein | 26.00 | 18.00 | 21.5 |
| Pea Fiber | 32.00 | 32.00 | 32.00 |
| Oat Flour | 7.00 | 15.00 | 15.00 |
| Flax Meal | 10.00 | 10.00 | 9 |
| Salt | 0.75 | 0.75 | 0 |
| Baking Powder | 3.25 | 3.25 | 1 |
| Sweetener | 0 | 0 | 0.5 |
| Total | 100.00 | 100.00 | 100 |

In the particular Example 4B, the ingredients may comprise cauliflower powder, psyllium powder, coconut flour, pea protein, pea fiber, oat flour, flax meal, salt, and baking powder according to the % wt. presented in Table 7. As may be seen in comparison to Example 4A, oat flour has increased for a corresponding decrease in pea protein; to alter the texture and taste of the product. As may be seen in comparison to Example 4C, we have included a sweetener to create a pre-sweetened cookie, removed the salt and reduced the baking powder to create a slightly more dense cookie, pea protein has been increased compared to Example 4B; to alter the texture and taste of the product.

100-g of the cookies/biscuit mix—Example 4A may contain the following: 6-g of other carbohydrate, 3-g of sugar, 29.5-g protein, and 45-g fiber. The total digestible carbohydrate is roughly 9-g/100-g of end product. 100-g of the cookies/biscuit mix—Example 4B may contain the following: 10.5-g of other carbohydrate, 3-g of sugar, 24-g of protein, and 45-g of fiber. The total digestible carbohydrate is approximately 13.5-g/100-g of end product.

100-g of the cookies/biscuit mix—Example 4C may contain the following: 6-g of other carbohydrate, 3-g of sugar, 29.5-g protein, and 45-g fiber. The total digestible carbohydrate is roughly 9-g/100-g of end product. 100-g of the cookies/biscuit mix—Example 4D may contain the following: 10.5-g of other carbohydrate, 3.1-g of sugar, 27-g of protein, and 45-g of fiber. The total digestible carbohydrate is approximately 13.6-g/100-g of end product.

According to Examples 5A, 5B and 5C below, the particular formulations may be suitable for producing a low carbohydrate, low sugar, high protein and high fiber pancake by mixing the formulations presented. The ingredients may comprise the ranges in Table 10 below.

TABLE 10

| Ingredient | % wt. |
|---|---|
| Cauliflower powder | 0-30 |
| Cabbage powder | 0-30 |
| Psyllium powder | 0-20 |
| Coconut Flour | 0-28 |
| Pea Protein/Faba Protein/Chickpea Protein/Other | 0-40 |
| Pea Fiber/Faba Fiber/Chickpea Fiber/Other | 0-40 |
| Oat Fiber | 0-40 |
| Oat Flour | 0-30 |
| Flax Seed | 0-40 |
| Olive/Coconut oil | 0-40 |
| Eggs (whole) | 0-60 |
| Baking powder | 0-10 |
| Baking Soda | 0-10 |
| Salt | 0-10 |
| Vanilla Essence | 0-10 |
| Lemon Extract | 0-10 |
| Stevia/Sweetener | 0-10 |

In the particular Example 5A, the ingredients may comprise cauliflower powder, psyllium powder, coconut flour, pea protein, pea fiber, oat flour, salt, baking powder, and baking soda according to the % wt. presented in Table 11.

TABLE 11
Example 5A to 5C Formulations

| | Example - 5A | Example - 5B | Example - 5C |
|---|---|---|---|
| | Formulation | Formulation | Formulation |
| Ingredient | (% wt.) | (% wt.) | (% wt.) |
| Cauliflower Powder | 5.00 | 5.00 | 5.00 |
| Psyllium Powder | 10.00 | 10.00 | 9.00 |
| Coconut flour | 9.00 | 9.00 | 9.00 |
| Pea Protein | 30.00 | 26.00 | 28.00 |
| Pea Fiber | 31.00 | 31.00 | 34.70 |
| Oat Flour | 11.00 | 15.00 | 10.50 |
| Salt | 0.75 | 0.75 | 0.80 |
| Baking Powder | 2.25 | 2.25 | 2.00 |
| Baking Soda | 1.00 | 1.00 | 1.00 |
| Total | 100.00 | 100.00 | 100 |

In the particular Example 5B, the ingredients may comprise cauliflower powder, psyllium powder, coconut flour, pea protein, pea fiber, oat flour, salt, baking powder, and baking soda according to the % wt. presented in Table 8. As may be seen in comparison to Example 5A, oat flour has been increased and a corresponding decrease in pea protein carried out; to alter the texture and taste of the product.

100-g of the pancake mix Example—5A may contain the following, 8-g of other carbohydrate, up to 4-g of sugar, protein up to 32 g, and fiber up to 43-g. The total digestible carbohydrate is roughly 12-g/100-g of end product pancake mix.

100-g of the pancake mix—Example 5B may contain the following, approximately 10.4-g of other carbohydrate, up to 4-g of sugar, protein up to 29-g, and fiber up to 43-g. The total digestible carbohydrate is roughly 14.4-g/100-g of end product.

100-g of the pancake mix—Example 5C may contain the following, approximately 8-g of other carbohydrate, up to 4-g of sugar, protein up to 30-g, and fiber up to 45-g. The total digestible carbohydrate is roughly 12-g/100-g of end product.

According to Examples 6A to 6F below, the particular formulations may be suitable for producing a low carbohydrate, low sugar, high protein and high fiber pizza crust by mixing the formulations presented. The ingredients may comprise the ranges in Table 12 below.

TABLE 12

| Ingredient | % wt. |
|---|---|
| Cauliflower Powder | 0-45 |
| Cabbage Powder | 0-45 |
| Psyllium Power | 0-35 |
| Coconut Flour | 0-28 |
| Lentil Flour | 0-45 |
| Pea Protein/Faba Protein/Chickpea Protein/Other | 0-70 |
| Pea Fiber]/Faba Fiber/Chickpea Fiber/Other | 0-70 |
| Oat Fiber | 0-70 |
| Chickpea Flour | 0-55 |
| Pea Starch | 0-15 |
| Tapioca flour | 0-15 |
| Acacia/Xanthan/Guar/Other | 0-5 |
| Baking powder | 0-10 |
| Baking Soda | 0-10 |
| Salt | 0-10 |
| Oat Flour | 0-30 |

In the particular Example 6A, the ingredients may comprise cauliflower powder, psyllium powder, pea protein, pea fiber, salt, baking powder, and baking soda according to the % wt. presented in Table 13.

TABLE 13
Example 6A to 6F Formulations

| | Example - | Example - | Example - | Example - | Example - | Example - |
|---|---|---|---|---|---|---|
| | 6A | 6B | 6C | 6D | 6E | 6F |
| | Formulation | Formulation | Formulation | Formulation | Formulation | Formulation |
| Ingredient | (% wt.) | (% wt.) | (% wt.) | (% wt.) | (% wt.) | (% wt.) |
| Cauliflower | 12.50 | 12.50 | 12.50 | 12.50 | 12.50 | 0 |
| Powder | | | | | | |
| Psyllium | 10.00 | 10.00 | 10.00 | 10.00 | 10.00 | 9 |
| Powder | | | | | | |
| Pea Protein | 31.50 | 31.50 | 31.50 | 31.50 | 21.50 | 24 |
| Pea Fiber | 42.00 | 27.00 | 37.00 | 22.00 | 37.00 | 42 |
| Oat Fiber | 0.00 | 15.00 | 0.00 | 15.00 | 0.00 | 0.00 |
| Oat Flour | 0.00 | 0.00 | 0.00 | 0.00 | 10.00 | 0.00 |
| Tapioca | 0.00 | 0.00 | 5.0 | 5.00 | 5.00 | 5.00 |
| flour | | | | | | |
| Chickpea | 0.00 | 0.00 | 0.00 | 0.00 | 0.00 | 12.3 |
| flour | | | | | | |
| Salt | 0.75 | 0.75 | 0.75 | 0.75 | 0.75 | 1.7 |
| Baking | 2.25 | 2.25 | 2.25 | 2.25 | 2.25 | 4.3 |
| Powder | | | | | | |
| Baking Soda | 1.00 | 1.00 | 1.00 | 1.00 | 1.00 | 1.7 |
| Total | 100.00 | 100.00 | 100.00 | 100.00 | 100.00 | 100 |

In the particular Example 6B, the ingredients may comprise cauliflower powder, psyllium powder, pea protein, pea fiber, oat fiber, salt, baking powder, and baking soda according to the % wt. presented in Table 13. As may be seen in comparison to Example 6A, oat fiber has been substituted for a corresponding decrease in pea fiber; to alter the texture and taste of the product.

100-g of the pizza mix produced by Examples 6A and 6B, may contain the following: 3-g/100-g of other carbohydrate, approximately 4-g/100-g of sugar, protein of about 32-g/100-g, and the fiber content may be about 49-g/100-g. The total digestible carbohydrate is roughly 7-g/100-g of end product.

In the particular Example 6C, the ingredients may comprise cauliflower powder, psyllium powder, pea protein, pea fiber, tapioca flour, salt, baking powder, and baking soda according to the % wt. presented in Table 13. As may be seen in comparison to Example 6A, tapioca flour has been introduced with a corresponding reduction in pea fiber; to alter the texture and taste of the product.

In the particular Example 6D, the ingredients may comprise cauliflower powder, psyllium powder, pea protein, pea fiber, oat fiber, tapioca flour, salt, baking powder, and baking soda according to the % wt. presented in Table 13. As may be seen in comparison to Example 6B, tapioca flour has been introduced with a corresponding reduction in pea fiber; to alter the texture and taste of the product.

As shown in example 6C and 6D the pizza mix, may contain the following; 7-g/100-g of other carbohydrate, approximately 4-g/100-g of sugar, protein of about 32-g/100-g, and the fiber content may be approximately 45-g/100-g. The total digestible carbohydrate is roughly 11-g/100-g of end product.

In the particular Example 6E, the ingredients may comprise cauliflower powder, psyllium powder, pea protein, pea fiber, oat flour, tapioca flour, salt, baking powder, and baking soda according to the % wt. presented in Table 13. As may be seen in comparison to Example 6C, Pea protein has been reduced with a corresponding inclusion of oat flour; to alter the texture and taste of the product.

100-g of the pizza mix produced from Example 6E formulation, may contain the following: 13-g/100-g of other carbohydrate, approximately 4-g/100-g of sugar, protein of about 25-g/100-g, and the fiber content may be about 45-g/100-g. The total digestible carbohydrate is roughly 17-g/100-g of end product.

In the particular Example 6F, the ingredients may comprise chickpea flour, psyllium powder, pea protein, pea fiber, tapioca flour, salt, baking powder, and baking soda according to the % wt. presented in Table 13. As may be seen in comparison to Example 6A, cauliflower powder has been removed and chickpea powder used as the base flour, pea protein was also reduced and an increase in baking powder, baking soda and salt; to reduce sugar content, to alter the texture and taste of the product.

100-g of the pizza mix produced from Example 6F formulation, may contain the following: 11-g/100-g of other carbohydrate, approximately 1-g/100-g of sugar, protein of about 26-g/100-g, and the fiber content may be about 47-g/100-g. The total digestible carbohydrate is roughly 12-g/100-g of end product.

According to other aspects, the compositions described herein may relate to a vegetable, legume, pulse, oat, seed and/or seed based flour which may be suitable to make flat breads, loaf-like breads, buns, cereal, crispy snack, cakes, preformed noodles, uncooked filled and unfilled pasta shapes including, but not limited to, spaghetti, fusilli, fettucine, castellane, conchiglie, rotini, rigatoni, spirali, penne, girandole, gemelli, macaroni, ravioli, vermicelli, lasagna, and rice-like pellet product. This composite flour may have subtle modifications based on the particular subtype of staple food. The end use products may be made by using variable proportions of vegetables, legumes, pulses, oat and seeds including desiccated cauliflower, broccoli, Cabbage, eggplant, psyllium husks, flax seed, chickpea, pea protein/faba protein/chickpea protein/other plant based protein, pea fiber/faba fiber,/chickpea fiber/other plant based fiber, oat fiber, oat, pea starch, tapioca flour, coconut and lentil suitable for various types of bread (including Indian style bread known as chapatti), noodles and pasta.

Although particular examples have been provided herein, numerous changes and modifications may be readily apparent to those skilled in the art. It is not desired to limit the invention to the exact composition and/or steps shown and described, and accordingly, all such suitable changes or modifications that may be resorted to are intended to fall within the scope of the claimed invention.

1.-47. (canceled)

48. A flour or dough mix comprising:
a psyllium powder of approximately 4% wt.;
a gum of approximately 2% wt. to 4% wt.;
a pea protein or a chickpea protein in a range of 16% wt. to 20% wt.;
a plant fiber in a range of 18% wt. to 49% wt.;
a chickpea flour in a range of 0% wt. to 27% wt;
a lentil flour in a range of 0% wt. to 27% wt.; and
a green banana powder of approximately 0% wt. to 16% wt.

49. The flour or dough mix according to claim 48, further comprising: a cauliflower powder of approximately 2.5% wt.

50. The flour or dough mix according to claim 48, further comprising: a coconut flour of approximately 8% wt.

51. The flour or dough mix according to claim 48, further comprising: a cabbage powder of approximately 2.5% wt.

52. The flour or dough mix according to claim 48, further comprising: an oat flour in a range of approximately 4.5% wt. to 16% wt.

53. The flour or dough mix according to claim 48, further comprising: a tapioca flour of approximately 5% wt. or approximately 8% wt.

54. The flour or dough mix according to claim 48, wherein the gum is selected from at least one of: a xanthan gum, a guar gum, and an acacia gum.

55. The flour or dough mix according to claim 48, further comprising: an inulin powder of approximately 8% wt.

56. The flour or dough mix according to claim 48, further comprising: a sugar alcohol or sweetener of approximately 2% wt. to 8% wt.

57. The flour or dough mix according to claim 48, further comprising: a starch of approximately 8% wt.

58. The flour or dough mix according to claim 48, further comprising: a baking soda of approximately 2% wt.

59. The flour or dough mix according to claim 48, wherein the flour or dough mix comprises a protein content between 18.7% wt. to 24.92% wt.

60. The flour or dough mix according to claim 48, wherein the flour or dough mix comprises a fiber content of between 25.36% wt. to 55.92% wt.

61. The flour or dough mix according to claim 48, wherein the plant fiber is selected from a pea fiber, a chickpea fiber, a corn bran, and a corn hull fiber.

62. A flour or dough mix comprising:
a cauliflower powder or a chickpea flour in a range of 0% wt. to 12.5% wt.;
a psyllium powder of approximately 5% wt. to 10% wt.;
a pea protein or a chickpea protein in a range of 15% wt. to 36% wt.;
a pea fibre or a chickpea fibre in a range of 18% wt. to 46.5% wt.; and
an oat flour in a range of 0% wt. to 25% wt.

63. The flour or dough mix according to claim 62, further comprising: a flax meal in a range of 9% wt. to 10% wt.

64. The flour or dough mix according to claim 63, further comprising: an oat fiber in a range of 14% wt. to 15% wt.

65. The flour or dough mix according to claim 64, further comprising: an unripe plantain flour of approximately 25% wt.

66. The flour or dough mix according to claim 65, further comprising: a coconut flour of approximately 7% wt to 9% wt.

67. The flour or dough mix according to claim 66, wherein the flour or dough mix comprises a protein content between 20.5% wt. to 36% wt.

68. The flour or dough mix according to claim 67, wherein the flour or dough mix comprises a fiber content of between 42% wt. to 49% wt.

69. The flour or dough mix according to claim 68, further comprising:
the psyllium powder of approximately 10% wt.;
the pea protein or the chickpea protein in a range of 18% wt. to 31.5% wt.;
the pea fiber or the chickpea fiber in a range of 22% wt. to 42% wt.;
a baking powder in a range of 1% wt. to 3.25% wt.; and
a salt in a range of 0.75% wt. to 1.7% wt.

70. The flour or dough mix according to claim 69, further comprising: an oat flour in a range of 7% wt. to 15% wt.

71. The flour or dough mix according to claim 70, further comprising: a baking soda in a range of 1% wt. to 1.7% wt.

72. The flour or dough mix according to claim 71, further comprising: a tapioca flour of approximately 5% wt.
